(19) United States
(12) Patent Application Publication
(10) Pub. No.: US 2020/0290124 A1
(43) Pub. Date: Sep. 17, 2020

(54) POWDER FOR FORMING THREE-DIMENSIONAL OBJECT, POWDER CONTAINED CONTAINER, THREE-DIMENSIONAL OBJECT PRODUCING METHOD, THREE-DIMENSIONAL OBJECT PRODUCING APPARATUS, AND NON-TRANSITORY RECORDING MEDIUM STORING PROGRAM FOR FORMING THREE-DIMENSIONAL OBJECT

(71) Applicant: Naoki OYA, Kanagawa (JP)

(72) Inventor: Naoki OYA, Kanagawa (JP)

(21) Appl. No.: 16/812,852

(22) Filed: Mar. 9, 2020

(30) Foreign Application Priority Data
Mar. 15, 2019 (JP) 2019-048824

(51) Int. Cl. B22F 3/105; B22F 1/00; B28B 1/00

(52) U.S. Cl. CPC B22F 3/1055; B33Y 10/00; B28B 1/001; B22F 1/0062

(57) ABSTRACT

Provided is a powder for forming a three-dimensional object, the powder including: a core material; and a sintering additive, wherein the sintering additive is in a state of being at least partially embedded in the core material.

### CROSS-REFERENCE TO RELATED APPLICATIONS

The present application claims priority under 35 U.S.C. § 119 to Japanese Patent Application No. 2019-048824 filed Mar. 15, 2019. The contents of which are incorporated herein by reference in their entirety.

### BACKGROUND OF THE INVENTION

### Field of the Invention

The present disclosure relates to a powder for forming a three-dimensional object, a powder contained container, a three-dimensional object producing method, a three-dimensional object producing apparatus, and a non-transitory recording medium storing a program for forming a three-dimensional object.

### Description of the Related Art

Examples of three-dimensional object forming methods by powder additive manufacturing (hereinafter may be referred to as “powder additive manufacturing methods”) include selective laser sintering (SLS) methods, electron beam sintering (EBM) methods, and binder jet (BJ) methods.

The binder jet methods are techniques of using a plaster as a powder material and discharging a binder ink from an inkjet head to solidify the plaster powder and form an object, or techniques of using sand as a powder material and discharging a binder resin from an inkjet head to form a template mold. Some binder jet methods use metals, ceramics, or glass as powder materials. When using a metal or ceramic powder, the powder particles are bound with each other using a binder and then heated and sintered, to form a final object. When forming an object with a sintering-resistant material that does not easily sinter when heated, it is known to add a sintering additive that promotes sintering.

For example, there has been proposed a powder for forming an object, wherein the powder is coated with a film containing a granular additive in order to form a less-contractive, high-quality sintered body for forming a three-dimensional object (for example, see Japanese Translation of PCT International Application Publication No. JP-T-2006-521264).

### SUMMARY OF THE INVENTION

According to one aspect of the present disclosure, a powder for forming a three-dimensional object contains a core material and a sintering additive. The sintering additive is in a state of being at least partially embedded in the core material.

### BRIEF DESCRIPTION OF THE DRAWINGS

FIG. 1 is a schematic view illustrating an example of a powder for forming a three-dimensional object according to a first embodiment;

FIG. 2A is a schematic view illustrating a three-dimensional object producing method using a powder for forming a three-dimensional object according to a first embodiment, illustrating a pre-sintering precursor (green body) forming step;

FIG. 2B is a schematic view illustrating a three-dimensional object producing method using a powder for forming a three-dimensional object according to a first embodiment, illustrating a degreasing step of degreasing a pre-sintering precursor (green body);

FIG. 2C is a schematic view illustrating a three-dimensional object producing method using a powder for forming a three-dimensional object according to a first embodiment, illustrating a liquid phase forming step in which a sintering additive forms a liquid phase at a high temperature;

FIG. 2D is a schematic view illustrating a three-dimensional object producing method using a powder for forming a three-dimensional object according to a first embodiment, illustrating a sintered body forming step in which a sintered body is formed when sintering terminates;

FIG. 3 is a schematic view illustrating an example of a powder for forming a three-dimensional object according to a second embodiment;

FIG. 4 is a schematic view illustrating an example of a powder for forming a three-dimensional object according to a third embodiment;

FIG. 5 is a schematic view illustrating an example of a powder for forming a three-dimensional object according to a fourth embodiment;

FIG. 6 is a schematic view illustrating an example of a powder for forming a three-dimensional object according to a fifth embodiment;

FIG. 7A is a schematic view illustrating a three-dimensional object producing method using a powder for forming a three-dimensional object according to a fifth embodiment, illustrating a pre-sintering precursor (green body) forming step;

FIG. 7B is a schematic view illustrating a three-dimensional object producing method using a powder for forming a three-dimensional object according to a fifth embodiment, illustrating a degreasing step of degreasing a pre-sintering precursor (green body);

FIG. 7C is a schematic view illustrating a three-dimensional object producing method using a powder for forming a three-dimensional object according to a fifth embodiment, illustrating a liquid phase forming step in which a sintering additive forms a liquid phase at a high temperature;

FIG. 7D is a schematic view illustrating a three-dimensional object producing method using a powder for forming a three-dimensional object according to a fifth embodiment, illustrating a sintered body forming step in which a sintered body is formed when sintering terminates;

FIG. 8 is a schematic plan view illustrating an example of a three-dimensional object producing apparatus according to a sixth embodiment;

FIG. 9 is a schematic side view of the three-dimensional object producing apparatus of FIG. 8;

FIG. 10 is a schematic cross-sectional view illustrating an object forming section of the three-dimensional object producing apparatus of FIG. 8;

FIG. 11 is a block diagram illustrating an example of a three-dimensional object producing apparatus according to a sixth embodiment;

FIG. 12A is a schematic cross-sectional view illustrating an example flow of an object forming operation in an object forming section of a three-dimensional object producing apparatus;

FIG. 12B is a schematic cross-sectional view illustrating another example flow of an object forming operation in an object forming section of a three-dimensional object producing apparatus;

FIG. 12C is a schematic cross-sectional view illustrating another example flow of an object forming operation in an object forming section of a three-dimensional object producing apparatus;

FIG. 12D is a schematic cross-sectional view illustrating another example flow of an object forming operation in an object forming section of a three-dimensional object producing apparatus;

FIG. 12E is a schematic cross-sectional view illustrating another example flow of an object forming operation in an object forming section of a three-dimensional object producing apparatus;

FIG. 13 is a superficial SEM image illustrating a state of a sintering additive being embedded in the surface of a core material in Example 1;

FIG. 14 is a superficial SEM image illustrating a state of a sintering additive being embedded in the surface of a core material in Example 2;

FIG. 15 is a superficial SEM image illustrating a state of a sintering additive being embedded in the surface of a core material in Example 3; and

FIG. 16 is a superficial SEM image illustrating a state of a sintering additive being embedded in the surface of a core material in Example 4.

### DESCRIPTION OF THE EMBODIMENTS

### (Powder for Forming Three-Dimensional Object)

A powder for forming a three-dimensional object of the present disclosure contains a core material and a sintering additive. The sintering additive is in a state of being at least partially embedded in the core material. The powder for forming a three-dimensional object further contains other components as needed.

The present disclosure has an object to provide a powder for forming a three-dimensional object, the powder being capable of suppressing voids or compositional variation in a sintered three-dimensional object.

The present disclosure can provide a powder for forming a three-dimensional object, the powder being capable of suppressing voids or compositional variation in a sintered three-dimensional object.

When forming an object with a sintering-resistant material by existing binder jet methods with addition of a sintering additive, there is a problem that the sintering additive segregates and disturbs sintering, to generate voids or compositional variation.

The present disclosure uses a powder for forming a three-dimensional object, wherein the powder contains a core material, a sintering additive struck into and immobilized in the surface of the core material, and a resin coating the core material and the sintering additive. This makes it possible to suppress voids or compositional variation in a sintered three-dimensional object.

The powder for forming a three-dimensional object of the present disclosure has an intergranular contact point between the core material and the sintering additive, because the sintering additive is struck into and immobilized in the surface of the core material. This allows the sintering additive to form a liquid phase when thermally treated, to promote sintering.

After the sintering additive is struck into the core material, the sintering additive is coated with a resin together with the core material.

This prevents the sintering additive from separating from the core material during object formation, and inhibits the core material from being oxidized and growing an oxide film. This facilitates sintering and eliminates segregation of the sintering additive and compositional variation.

### <Core Material>

As the core material, a sintering-resistant material is preferable. The sintering-resistant material refers to a material that is not easily sintered when heated. More specifically, the sintering-resistant material refers to a material that has an extremely high melting point or solidus line temperature and cannot be thermally treated with a typical heating device that cannot handle a temperature higher than the melting point or solidus line temperature, or a material that, in spite of having a low melting point or solidus line temperature, is inhibited from being sintered due to an oxide film formed over the particle surface of the material.

Examples of the sintering-resistant material includes metals, ceramics, and carbides.

Examples of the metals include aluminum, tungsten, titanium, molybdenum, and niobium, or alloys of these metals.

Examples of the ceramics include aluminum nitride and alumina.

Examples of the carbides include tungsten carbide, titanium carbide, chromium carbide, and silicon carbide.

It is preferable that the core material have a granular shape. Examples of the granular shape include a spherical shape and an elliptic shape.

The volume average particle diameter of the core material is not particularly limited, may be appropriately selected depending on the intended purpose, and is preferably 0.1 micrometers or greater but 500 micrometers or less, more preferably 5 micrometers or greater but 300 micrometers or less, and yet more preferably 10 micrometers or greater but 250 micrometers or less.

When the volume average particle diameter of the core material is 0.1 micrometers or greater but 500 micrometers or less, the efficiency of producing a three-dimensional object is excellent, and treatability and handleability are good. When the volume average particle diameter of the core material is 500 micrometers or less, a thin layer to be formed of the powder for forming a three-dimensional object will be filled with the powder for forming a three-dimensional object at an improved filling rate, making it less likely that a three-dimensional object to be obtained will have, for example, voids or compositional variation.

The volume average particle diameter of the core material can be measured with a known particle diameter measuring instrument such as MICROTRAC HRA (available from Nikkiso Co., Ltd.) according to a known method.

### <Sintering Additive>

The sintering additive is an agent added when sintering the core material, to promote sintering.

The sintering additive is in a state of being at least partially embedded in the core material. The sintering additive needs only to be at least partially embedded, but may be wholly embedded. Specifically, it is preferable that the sintering additive be embedded by a length that is greater than or equal to 10%, more preferably greater than or equal to 50%, and yet more preferably greater than or equal to 70% of the volume average particle diameter of the sintering additive, when measured from the surface of the core material.

The sintering additive that is in a state of being embedded by a length greater than or equal to 10% of the volume average particle diameter of the sintering additive when measured from the surface of the core material has advantages of being prevented from separating from the core material during object formation and facilitating sintering by inhibiting the core material from being oxidized to grow an oxide film

The volume average particle diameter of the sintering additive is preferably 10 nm or greater but 10 micrometers or less and more preferably 100 nm or greater but 5 micrometers or less.

The volume average particle diameter of the sintering additive can be measured with a known particle diameter measuring instrument such as MICROTRAC HRA (available from Nikkiso Co., Ltd.) according to a known method.

It is possible to confirm that the sintering additive is in a state of being embedded in the core material, by, for example, observing a superficial SEM image and a cross-sectional SEM image.

When the core material is aluminum or an alloy of aluminum, examples of the sintering additive include silicon, copper, tin, magnesium, iron, manganese, titanium, nickel, zinc, and chromium, or alloys of these metals.

It is preferable that the sintering additive have a granular shape. Examples of the granular shape include a spherical shape, an elliptic shape, a sharp shape with a low sphericity, a polygonal shape, a rectangular shape, a flat shape, and a plate shape. Among these shapes, a sharp shape with a low sphericity is particularly preferable because a sharp shape makes it easy for the sintering additive to be struck into the core material when the core material and the sintering additive are stirred.

It is preferable that the sintering additive be embedded in the core material by 100 nm or greater from the surface of the core material. This makes an oxide film of the core material thinner or non-existent at the positions at which the sintering additive is embedded, to further promote sintering. The thickness of the oxide film of the core material is, for example, about from several nanometers through some tens of nanometers when the core material is aluminum. Hence, the oxide film is substantially non-existent at the positions at which the sintering additive is embedded by 100 nm or greater.

It is preferable that all of the elements that constitute the sintering additive be included among the elements constituting the core material. This ensures that the elements constituting the core material as the material of the powder for forming a three-dimensional object will be the same as the elements that will constitute a sintered three-dimensional object, ensuring prevention of mixing of impurity elements.

Examples of such a combination of the materials include a combination of an AlSi₁₀Mg alloy as the core material and silicon or magnesium as the sintering additive, a combination of ADC₁₂ as the core material and silicon or copper as the sintering additive, a combination of a copper-tungsten alloy as the core material and copper as the sintering additive, and a combination of a silver-tungsten alloy as the core material and silver as the sintering additive.

When the core material and the sintering additive form a liquid phase during sintering, it is preferable that the following formula: S_{B}>S_{A} be satisfied, where S_{A} represents solubility of the liquid phase in a solid is phase and S_{B} represents solubility of the solid phase in the liquid phase, i.e., it is preferable that the solubility of the solid phase in the liquid phase be higher. This increases the liquid phase between the solid-phase particles, allows the voids between the solid-phase particles to be filled, and better densifies a sintered body of a three-dimensional object.

Examples of such a combination of the core material and the sintering additive include a combination of aluminum as the core material and tin as the sintering additive.

It is preferable that the core material and the sintering additive have an intergranular contact point. Examples of the method for making an intergranular contact point include striking the sintering additive into the core material. Striking means embedding the sintering additive in the core material. Examples of the striking method include stirring by a Henschel mixer, and stirring by a hybridizer. Of these methods, stirring by a Henschel mixer is preferable.

Stirring by a Henschel mixer is a method of fluidizing powders upward by a lower blade rotating at a high speed and then shearing the powders by an upper blade, to disperse and mix the powders. In the dispersing/mixing process, the sintering additive is struck into the surface of the core material. This method can be performed using, for example, a Henschel mixer FM10B/I available from Nippon Coke & Engineering Co., Ltd. Specifically, the device is loaded with the core material and the sintering additive in predetermined amounts, and the mixer is operated to stir at a predetermined rotation speed for a predetermined stirring time. In order to prevent temperature rise in the device, intervals may be provided, with a suspension per stirring.

The mixing ratio between the core material and the sintering additive is not particularly limited and may be appropriately selected depending on the intended purpose. A core material:sintering additive mixing ratio by volume is preferably from 99.9:0.1 through 7:3 and more preferably from 99:1 through 8:2.

It is preferable that the sintering additive be immobilized by being embedded in the core material. Being immobilized is defined as the sintering additive having a fixed positional relationship with the core material. Examples of the immobilizing method include a method of coating the surface of the core material with a resin.

In terms of preventing the core material from being oxidized, it is preferable that the core material be coated with a resin. For example, silicon serving as the sintering additive forms a liquid phase with aluminum serving as the core material, to break the oxide film and promote sintering. Because aluminum and silicon have a contact point, aluminum and silicon can easily form a liquid phase.

It is preferable that also the sintering additive be coated with the resin together with the core material. This makes it possible to prevent the sintering additive from peeling from the core material during object formation. Further, when the sintering additive has ignitability (i.e., a high fire-catching property), resin coating suppresses oxidization of the sintering additive and prevents the sintering additive from igniting. Examples of such an ignitable sintering additive include silicon, tin, magnesium, and zinc, and alloys of these metals with aluminum.

### <Resin>

The resin is not particularly limited and may be appropriately selected depending on the intended purpose so long as the resin dissolves in a liquid and solidifies. When the liquid is water-based, examples of the resin include polyvinyl alcohol resins, polyacrylic acid resins, cellulose, starch, gelatin, vinyl resins, amide resins, imide resins, acrylic resins, and polyethylene glycol. One of these resins may be used alone or two or more of these resins may be used in combination.

A liquid used for immobilizing the core material and the sintering additive is not particularly limited and may be appropriately selected depending on the intended purpose so long as the liquid can immobilize the core material and the sintering additive by dissolving the resin. Examples of the liquid include water, alcohols such as ethanol, aqueous media such as ethers and ketones, aliphatic hydrocarbons, ether-based solvents such as glycol ether, ester-based solvents such as ethyl acetate, ketone-based solvents such as methyl ethyl ketone, and higher alcohols. One of these liquids may be used alone or two or more of these liquids may be used in combination.

The coating thickness of the resin over the core material on an average thickness basis is preferably 5 nm or greater but 1,000 nm or less, more preferably 5 nm or greater but 500 nm or less, yet more preferably 50 nm or greater but 300 nm or less, and particularly preferably 100 nm or greater but 200 nm or less.

When the average thickness as the coating thickness is 5 nm or greater, a solidified product (pre-sintering precursor) of (a layer) of the powder for forming a three-dimensional object, formed by applying the liquid to the powder for forming a three-dimensional object, has an improved strength, and does not cause problems such as shape collapse during post-treatment such as sintering or post-handling. When the average thickness as the coating thickness is 1,000 nm or less, a solidified product (pre-sintering precursor) of (a layer) of the powder for forming a three-dimensional object, formed by applying the liquid to the powder for forming a three-dimensional object, has an improved dimensional accuracy.

The average thickness can be measured with, for example, a scanning tunneling microscope (STM), an atomic force microscope (AFM), and a scanning electron microscope (SEM) after the powder for forming a three-dimensional object is embedded in, for example, an acrylic resin and then subjected to, for example, etching, to expose the surface of the core material.

The coating ratio (area ratio) of the resin over the surface of the core material is not particularly limited, may be appropriately selected depending on the intended purpose, and is preferably 15% or greater, more preferably 50% or greater, and yet more preferably 80% or greater.

When the coating ratio is 15% or greater, a solidified product (pre-sintering precursor) of (a layer) of the powder for forming a three-dimensional object, formed by applying the liquid to the powder for forming a three-dimensional object, has a sufficient strength, and does not cause problems such as shape collapse during post-treatment such as sintering or post-handling. Further, a solidified product (pre-sintering precursor) of (a layer) of the powder for forming a three-dimensional object, formed by applying the liquid to the powder for forming a three-dimensional object, has an improved dimensional accuracy.

The coating ratio may be obtained by, for example, observing an image of the powder for forming a three-dimensional object and calculating the average of the ratio (%) of the area of the portion coated with the resin to the total area of the surface of the powder as the coating ratio, or may be measured by element mapping of the portion coated with the resin by, for example, energy dispersive X-ray spectroscopy such as SEM-EDS.

### <Other Components>

Examples of the other components that may be contained include an arbitrary deterioration preventive agent, a fluidizer, a toughening agent, a flame retardant, a plasticizer, additives such as a thermostable additive and a crystal nucleating agent, polymer particles of, for example, non-crystalline resins

### Production of Powder for Forming Three-Dimensional Object

The method for producing the powder for forming a three-dimensional object is not particularly limited and may be appropriately selected depending on the intended purpose. Preferable examples of the method include a method of coating the core material embedded with the sintering additive with the resin as described above.

The method for coating the surface of the core material with the resin is not particularly limited and may be appropriately selected from known coating methods. Preferable examples of the coating method include a rolling fluidized coating method, a spray drying method, a stirring mixing adding method, a dipping method, and a kneader coating method. These coating methods can be performed using, for example, known, commercially available various coating machines and granulators.

As described above, the powder for forming a three-dimensional object of the present disclosure contains the core material formed of a sintering-resistant material and the sintering additive, and the sintering additive is embedded and immobilized in the core material and forms a liquid phase with the core material at a high temperature. Therefore, the powder for forming a three-dimensional object can be suitably used with a powder contained container of the present disclosure, a three-dimensional object producing apparatus of the present disclosure, and a three-dimensional object producing method of the present disclosure described below.

### (Powder Contained Container)

A powder contained container of the present disclosure is obtained by filling the powder for forming a three-dimensional object of the present disclosure in a container.

For example, the shape, structure, size, and material of the container are not particularly limited and may be appropriately selected depending on the intended purpose. Examples of the container include a powder contained bag formed of, for example, aluminum laminate film or resin film, a powder contained cartridge, and a powder contained tank.

### (Three-Dimensional Object Producing Method, Three-Dimensional Object Producing Apparatus, and Non-Transitory Recording Medium Storing Program for Forming Three-Dimensional Object)

A three-dimensional object producing method of the present disclosure includes a powder layer forming step, a powder layer solidifying step, a pre-sintering precursor producing step, and a sintering step, and further includes other steps as needed.

A three-dimensional object producing apparatus of the present disclosure includes a powder layer forming unit, a powder layer solidifying unit, a pre-sintering precursor producing unit, and a sintering unit, and further includes other units as needed.

A non-transitory recording medium storing a program for forming a three-dimensional object of the present disclosure stores a program for forming a three-dimensional object, the program causing a computer to execute a process including: forming a powder layer using a powder for forming a three-dimensional object containing a core material and a sintering additive, wherein the sintering additive is in a state of being at least partially embedded in the core material; applying to an object forming region of the powder layer, a liquid that can dissolve a resin coating the core material of the powder for forming a three-dimensional object, to solidify the object forming region; repeating forming a powder layer and solidifying the powder layer to produce a pre-sintering precursor; and sintering the pre-sintering precursor.

Control being performed by, for example, a controlling section of the “three-dimensional object producing apparatus” of the present disclosure is the same as the “three-dimensional object producing method” of the present disclosure being performed. Hence, the details of the “three-dimensional object producing method” of the present disclosure will also be specified through description of the “three-dimensional object producing apparatus” of the present disclosure. The “non-transitory recording medium storing a program for forming a three-dimensional object” of the present disclosure realizes the “three-dimensional object producing apparatus” of the present disclosure with the use of, for example, computers as hardware resources. Hence, the details of the “non-transitory recording medium storing a program for forming a three-dimensional object” of the present disclosure will also be specified through description of the “three-dimensional object producing apparatus” of the present disclosure.

The program for forming a three-dimensional object may be stored in a recording medium. This enables the program for forming a three-dimensional object to be installed in, for example, a computer. The recording medium having stored therein the program for forming a three-dimensional object may be a non-transitory recording medium.

The non-transitory recording medium is not particularly limited and may be appropriately selected depending on the intended purpose. Examples of the non-transitory recording medium include a CD-ROM (Compact Disc-Read Only Memory) and a DVD-ROM (Digital Versatile Disc-ROM).

### Powder Layer Forming Step and Powder Layer Forming Unit

The powder layer forming step is a step of forming a powder layer using the powder for forming a three-dimensional object of the present disclosure, and is performed by the powder layer forming unit.

It is preferable to form a layer of the powder for forming a three-dimensional object over a support.

### Support

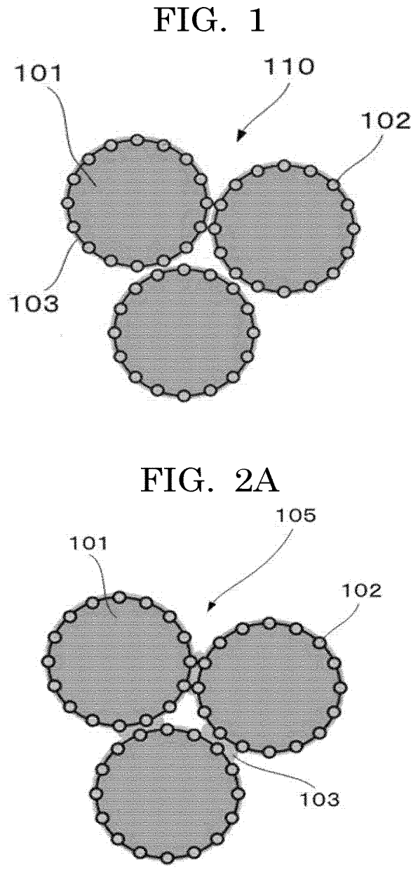

The support is not particularly limited and may be appropriately selected depending on the intended purpose so long as the powder for forming a three-dimensional object can be placed over the support. Examples of the support include a table having a placing surface over which the powder for forming a three-dimensional object is placed, and a base plate of the device described in FIG. 1 of Japanese Unexamined Patent Application Publication No. 2000-328106.

The surface of the support, i.e., the placing surface over which the powder for forming a three-dimensional object is placed may be, for example, a smooth surface or a rough surface, or a planar surface or a curved surface. It is preferable that the placing surface have a low affinity with the resin of the powder for forming a three-dimensional object when the resin is dissolved.

It is preferable that the affinity of the placing surface with the resin dissolved be lower than the affinity of the core material with the resin dissolved, because this makes it easy to remove an obtained three-dimensional object from the placing surface.

### Formation of Powder Layer

The method for placing the powder for forming a three-dimensional object over the support is not particularly limited and may be appropriately selected depending on the intended purpose. Preferable examples of a method for placing the powder for forming a three-dimensional object in the form of a thin layer include a method of using, for example, a known counter rolling mechanism (counter roller), used in the selective laser sintering method described in Japanese Patent No. 3607300, a method of spreading the powder for forming a three-dimensional object into the form of a thin layer using such a member as a brush, a roller, or a blade, a method of spreading the powder for forming a three-dimensional object into the form of a thin layer using a press member to press the surface of the powder for forming a three-dimensional object, and a method of using a known powder additive manufacturing apparatus.

Placing the powder for forming a three-dimensional object over the support in the form of a thin layer using, for example, the counter rolling mechanism (counter roller), the brush, roller, or blade, or the press member may be performed in the following manner.

That is, using, for example, the counter rolling mechanism (counter roller), the brush, roller, or blade, or the press member, the powder for forming a three-dimensional object is placed over the support disposed within an outer fame (may also be referred to as “mold”, “hollow cylinder”, and “tubular structure”) in a manner that the support can be lifted up and down while sliding on the internal wall of the outer frame. When the support used is a member that can be lifted up and down within the outer frame, the support may be disposed at a position slightly below the upper end opening of the outer frame, i.e., at a position below the upper end opening by what corresponds to the thickness of the powder layer, and then the powder for forming a three-dimensional object may be placed over the support. In this way, the powder for forming a three-dimensional object can be placed over the support in the form of a thin layer.

When a liquid is caused to act on the powder for forming a three-dimensional object placed in the form of a thin layer in the manner described above, the layer solidifies (the powder layer solidifying step).

The liquid is not particularly limited and may be appropriately selected depending on the intended purpose so long as the liquid can dissolve the resin coating the core material. Examples of the liquid include water, alcohols such as ethanols, aqueous media such as ethers and ketones, aliphatic hydrocarbons, ether-based solvents such as glycol ether, ester-based solvents such as ethyl acetate, ketone-based solvents such as methyl ethyl ketone, and higher alcohols. Among these liquids, the aqueous media are preferable and the water is more preferable in terms of environmental hazardousness and discharging stability (little viscosity change over time) when discharging the liquid by an inkjet method. The aqueous medium may be the water containing any other component than water, such as the alcohol in a low amount. When the medium of the liquid is an aqueous medium, it is preferable that an organic material mainly contain a water-soluble organic material.

Then, when the powder for forming a three-dimensional object is placed in the form of a thin layer in the same manner as described above over the solidified product of the thin layer obtained above and the liquid is caused to act on (the layer) of the powder for forming a three-dimensional object placed in the form of a thin layer, solidification occurs. This solidification occurs not only in (the layer) of the powder for forming a three-dimensional object placed in the form of a thin layer but also between (the layer) of the powder for forming a three-dimensional object and the underlying solidified product of the thin layer obtained by the previous solidification. As a result, a solidified product (pre-sintering precursor) having a thickness corresponding to about two layers of the powder for forming a three-dimensional object placed in the form of a thin layer is obtained.

Alternatively, an automatic, quick manner using the known powder additive manufacturing apparatus may be employed to place the powder for forming a three-dimensional object over the support in the form of a thin layer. Typically, the powder additive manufacturing apparatus includes a recoater configured to laminate layers of the powder for forming a three-dimensional object, a movable supplying tank configured to supply the powder for forming a three-dimensional object onto the support, and a movable forming tank in which the powder for forming a three-dimensional object is placed in the form of a thin layer and laminated. In the powder additive manufacturing apparatus, it is possible to constantly dispose the surface of the supplying tank slightly above the surface of the forming tank by lifting up the supplying tank, by lifting down the forming tank, or by both, it is possible to place the powder for forming a three-dimensional object in the form of a thin layer by actuating the recoater from the supplying tank side, and it is possible to laminate thin layers of the powder for forming a three-dimensional object by repeatedly moving the recoater.

The thickness of a layer of the powder for forming a three-dimensional object is not particularly limited and may be appropriately selected depending on the intended purpose. For example, the average thickness per layer is preferably 30 micrometers or greater but 500 micrometers or less and more preferably 60 micrometers or greater but 300 micrometers or less.

When the thickness is 30 micrometers or greater, a solidified product (pre-sintering precursor) of (a layer) of the powder for forming a three-dimensional object, formed by applying the liquid to the powder for forming a three-dimensional object, has a sufficient strength, and does not cause problems such as shape collapse during post-treatment such as sintering or post-handling. When the thickness is 500 micrometers or less, a solidified product (pre-sintering precursor) of (a layer) of the powder for forming a three-dimensional object, formed by applying the liquid to the powder for forming a three-dimensional object, has an improved dimensional accuracy.

The average thickness may be measured by any method that is not particularly limited and can be measured by a known method.

### Powder Layer Solidifying Step and Powder Layer Solidifying Unit

The powder layer solidifying step is a step of applying a liquid that can dissolve the resin to a powder layer formed in the powder layer forming step to solidify a predetermined region of the powder layer, and is performed by the powder layer solidifying unit.

The method for applying the liquid to the powder layer is not particularly limited and may be appropriately selected depending on the intended purpose. Examples of the method include a dispenser method, a spray method, and an inkjet method. In order to perform these methods, a known apparatus can be suitably used as the powder layer solidifying unit.

Among these methods, the dispenser method has excellent liquid droplet quantitativity, but has a small coating coverage. The spray method can form a minute jet of the materials easily and has a wide coating coverage and excellent coatability, but has a poor liquid droplet quantitativity and causes the powder for forming a three-dimensional object to scatter due to a spray current. Hence, in the present disclosure, the inkjet method is particularly preferable. The inkjet method is preferable because the inkjet method is better than the spray method in liquid droplet quantitativity, can obtain a greater coating coverage than can be obtained by the dispenser method, and can form a complicated three-dimensional shape with a good accuracy efficiently.

In the case of the inkjet method, the powder layer solidifying unit includes nozzles capable of applying the liquid to the powder layer by the inkjet method. Nozzles (jet heads) of a known inkjet printer can be suitably used as the nozzles, and the inkjet printer can be suitably used as the powder layer solidifying unit. Preferable examples of the inkjet printer include SG7100 available from Ricoh Company, Ltd. The inkjet printer is preferable because the inkjet printer can realize rapid coating owing to the capability of dropping a liquid from a head in a large amount at a time and covering a large area.

In the present disclosure, use of the inkjet printer capable of applying the liquid accurately and highly efficiently is advantageous to the liquid because the liquid, which is free of solid matters such as particles and polymeric high-viscosity materials such as resins, will not, for example, clog or corrode the nozzles or the nozzle heads of the inkjet printer, can efficiently permeate the resin of the powder for forming a three-dimensional object when applied (discharged) to a layer of the powder for forming a three-dimensional object, ensuring an excellent productivity of a three-dimensional object, and will deliver no polymeric components such as resins and hence cause, for example, no unexpected volume increase, ensuring that a solidified product having a good dimensional accuracy can be obtained easily, in a short time, and efficiently.

### Powder Storage

The powder storage is a member in which the powder for forming a three-dimensional object is stored. For example, the size, shape, and material of the powder storage are not particularly limited and may be appropriately selected depending on the intended purpose. Examples of the powder storage include a reservoir, a bag, a cartridge, and a tank.

### Liquid Storage

The liquid storage is a member in which the liquid is stored. For example, the size, shape, and material of the liquid storage are not particularly limited and may be appropriately selected depending on the intended purpose. Examples of the liquid storage include a reservoir, a bag, a cartridge, and a tank.

### Sintering Step and Sintering Unit

The sintering step is a step of sintering the solidified product (pre-sintering precursor) formed in the powder layer solidifying step. Through the sintering step, the solidified product can be made into an integrated compact of a metal or a ceramic (a sintered body of a three-dimensional object). Examples of the sintering unit include a known sintering furnace.

In the present disclosure, use of the powder for forming a three-dimensional object obtained by striking and immobilizing the sintering additive in the surface of the core material formed of a sintering-resistant material and coating the resultant with the resin makes it possible to suppress voids or compositional variation in a sintered three-dimensional object.

### Other Steps and Other Units

Examples of the other steps include a drying step, a surface protection treatment step, and a painting step.

Examples of the other units include a drying unit, a surface protection treatment unit, and a painting unit.

The drying step is a step of drying a solidified product (pre-sintering precursor) obtained in the powder layer solidifying step. In the drying step, not only may the water contained in the solidified product be removed, but also any organic material contained in the solidified product may be removed (degreased). Examples of the drying unit include known dryers.

The surface protection treatment step is a step of performing, for example, formation of a protective layer over the solidified product (pre-sintering precursor) formed in the powder layer solidifying step. Through the surface protection treatment step, for example, durability that, for example, enables the solidified product (pre-sintering precursor) to be used as is can be imparted to the surface of the solidified product (pre-sintering precursor). Specific examples of the protective layer include a water-resistant layer, a weatherable layer, a light-resistant layer, a heat-insulating layer, and a gloss layer. Examples of the surface protection treatment unit include known surface protection treatment apparatuses such as spray machines and coating machines.

The painting step is a step of painting the solidified product (pre-sintering precursor) formed in the powder layer solidifying step. Through the painting step, the solidified product (pre-sintering precursor) can be colored in a desired color. Examples of the painting unit include known painting apparatuses such as painting apparatuses using, for example, spray, a roller, and a brush.

Embodiments of the powder for forming a three-dimensional object and the three-dimensional object producing method using the powder for forming a three-dimensional object will be described in detail with reference to the drawings.

In the drawings, the same components will be denoted by the same reference numerals and redundant description of the same components may be skipped. For example, the number, position, and shape of the components are not limited to as specified in the embodiments, but may be any number, position, and shape that are suitable for working the present disclosure.

### <First Embodiment>

FIG. 1 is a view illustrating a powder for forming a three-dimensional object according to the first embodiment of the present disclosure.

A powder for forming a three-dimensional object 110 of FIG. 1 contains a core material 101 formed of a sintering-resistant material, a sintering additive 102 for promoting sintering of the core material, and a resin 103 coating the core material 101. The sintering additive 102 is embedded in the core material 101, and the core material 101 is coated with the resin 103. The core material 101 and the sintering additive 102 are materials that form a liquid phase at a high temperature.

In the present embodiment, the core material 101 is aluminum, the sintering additive 102 is silicon, and the resin 103 is polyvinyl alcohol.

The core material 101 and the sintering additive 102 have an intergranular contact point. Not is the sintering additive simply contained in a resin coating as hitherto has been, but the sintering additive 102 is provided in the state of having an intergranular contact point with the core material 101. This allows the sintering additive 102 to form a liquid phase at a high temperature and efficiently promote sintering. After the sintering additive is struck into the core material, the sintering additive is coated with the resin together with the core material. This provides advantages of preventing the sintering additive from separating from the core material during object formation, inhibiting the core material from being oxidized and growing an oxide film, and facilitating sintering without segregation of the sintering additive and without consequent compositional variation.

Examples of the method for making an intergranular contact point include striking the sintering additive 102 into the core material 101. Examples of the striking method include stirring by a hybridizer.

In the present embodiment, the sintering additive 102 is immobilized in the surface of the core material 101. Examples of the immobilizing method include a method of coating with a resin in order to obtain a fixed positional relationship between the sintering additive 102 and the core material 101.

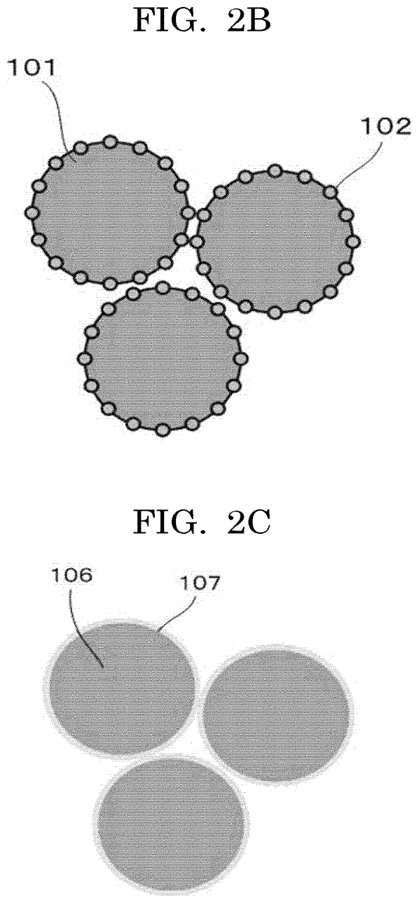

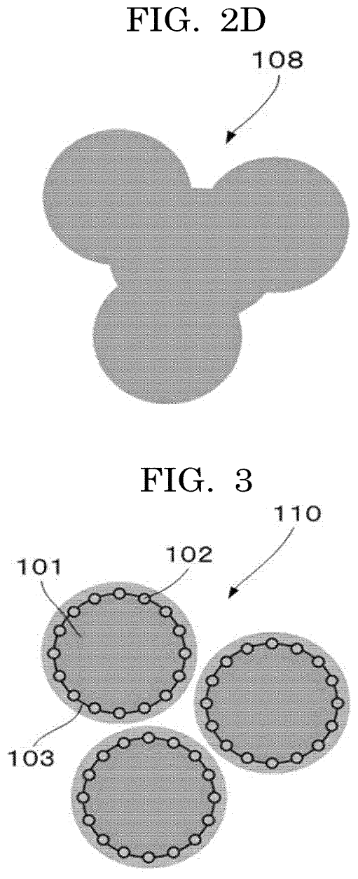

With reference to FIG. 2A to FIG. 2D, a three-dimensional object producing method using the powder for forming a three-dimensional object according to the first embodiment described above will be described below.

First, the powder for forming a three-dimensional object 110 according to the first embodiment is flattened by, for example, a roller in an object forming tank (unillustrated), and then a liquid that dissolves and solidifies the coating resin is dropped to an object forming region. These steps are repeated to produce a pre-sintering precursor 105 (hereinafter may also be referred to as “green body”) as illustrated in FIG. 2A.

Next, as illustrated in FIG. 2B, the green body 105 is heated at a temperature higher than or equal to the pyrolysis temperature of the resin in a degreasing/sintering furnace. As a result, the green body 105 is degreased of the resin component.

Next, as illustrated in FIG. 2C, the green body is further heated at a high temperature. As a result, the core material 101 and the sintering additive 102 form a liquid phase 107 at the contact point between the core material 101 and the sintering additive 102, and undergo liquid-phase sintering. In FIG. 2C, the reference numeral 106 denotes a solid phase. Generally, aluminum serving as the core material is inhibited from element diffusion due to the presence of an oxide film, and cannot easily sinter.

Here, silicon serving as the sintering additive 102 forms a liquid phase 107 with aluminum serving as the core material to break the oxide film and promote sintering. In the present embodiment, because aluminum and silicon have a contact point, aluminum and silicon can easily form a liquid phase. In addition, in the present embodiment, because aluminum is coated with the resin, aluminum is inhibited from growing an oxide film, to further facilitate sintering. The resin coating can also prevent the sintering additive from peeling from the core material during object formation.

Finally, as illustrated in FIG. 2D, sintering terminates, and a dense sintered body 108 having no voids or compositional variation is obtained.

### <Second Embodiment>

FIG. 3 is a view illustrating a powder for forming a three-dimensional object according to the second embodiment. In a powder for forming a three-dimensional object 110 of FIG. 3, a sintering additive 102 is immobilized by being coated with a resin 103 together with a core material 101. This provides a greater protection against peeling of the sintering additive 102 from the core material 101 during object formation. When the sintering additive 102 has ignitability, coating of the resin 103 can suppress oxidization of the sintering additive 102 and prevent the sintering additive 102 from igniting.

Examples of the sintering additive 102 having ignitability (i.e., a high fire-catching property) include silicon, tin, magnesium, and zinc, or alloys of these metals with aluminum.

In the present embodiment, the core material 101 is aluminum, the sintering additive 102 is silicon, and the resin 103 is polyvinyl alcohol.

A three-dimensional object producing method using the powder for forming a three-dimensional object according to the second embodiment is the same as in FIG. 2A to FIG. 2D of the first embodiment. Therefore, description about the three-dimensional object producing method is skipped.

### <Third Embodiment>

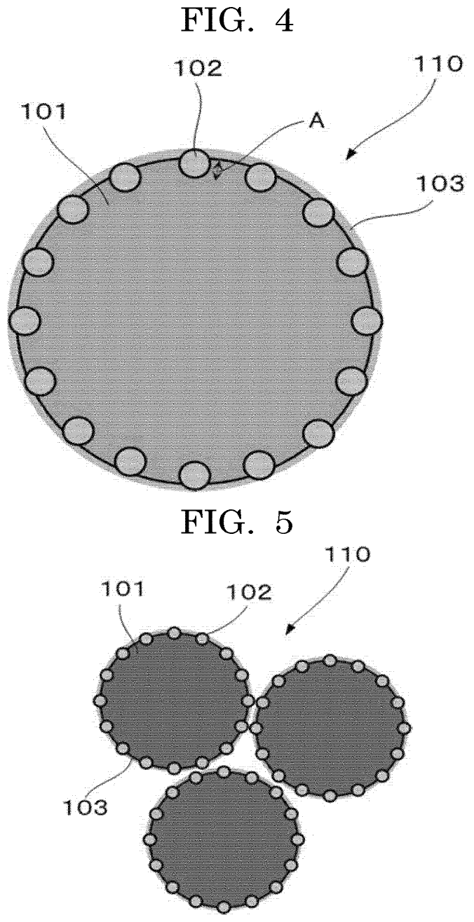

FIG. 4 is a view illustrating a powder for forming a three-dimensional object according to the third embodiment of the present disclosure. In a powder for forming a three-dimensional object 110 of FIG. 4, a sintering additive 102 is embedded in a core material 101 by 100 nm or greater from the surface of the core material as denoted by A in FIG. 4. This prevents the sintering additive 102 from peeling from the core material and makes the oxide film of the core material 101 thinner or non-existent at the positions at which the sintering additive 102 is embedded, to further promote sintering.

The thickness of the oxide film of the core material 101 is, for example, from some nanometers through some tens of nanometers when the core material is aluminum. Hence, the oxide film is substantially non-existent at the positions at which the sintering additive 102 is embedded by 100 nm or greater.

In the present embodiment, the core material 101 is aluminum, the sintering additive 102 is silicon, and the resin 103 is polyvinyl alcohol.

A three-dimensional object producing method using the powder for forming a three-dimensional object according to the third embodiment is the same as in FIG. 2A to FIG. 2D of the first embodiment. Therefore, description about the three-dimensional object producing method is skipped.

### <Fourth Embodiment>

FIG. 5 is a view illustrating a powder for forming a three-dimensional object according to the fourth embodiment of the present disclosure. In a powder for forming a three-dimensional object 110 of FIG. 5, all of the elements that constitute the sintering additive 102 are included among the elements constituting the core material 101. This ensures that the elements constituting the core material 101 as the material of the powder for forming a three-dimensional object will be the same as the elements that will constitute a sintered object, ensuring prevention of mixing of impurity elements. Examples of such a combination of the materials include a combination of an AlSi₁₀Mg alloy as the core material and silicon/magnesium as the sintering additive, a combination of ADC₁₂ as the core material and silicon/copper as the sintering additive, a combination of a copper-tungsten alloy as the core material and copper as the sintering additive, and a combination of a silver-tungsten alloy as the core material and silver as the sintering additive.

In the present embodiment, the core material 101 is an AlSi₁₀Mg alloy, the sintering additive 102 is silicon/magnesium, and the resin 103 is polyvinyl alcohol.

A three-dimensional object producing method using the powder for forming a three-dimensional object according to the fourth embodiment is the same as in FIG. 2A to FIG. 2D of the first embodiment. Therefore, description about the three-dimensional object producing method is skipped.

### <Fifth Embodiment>

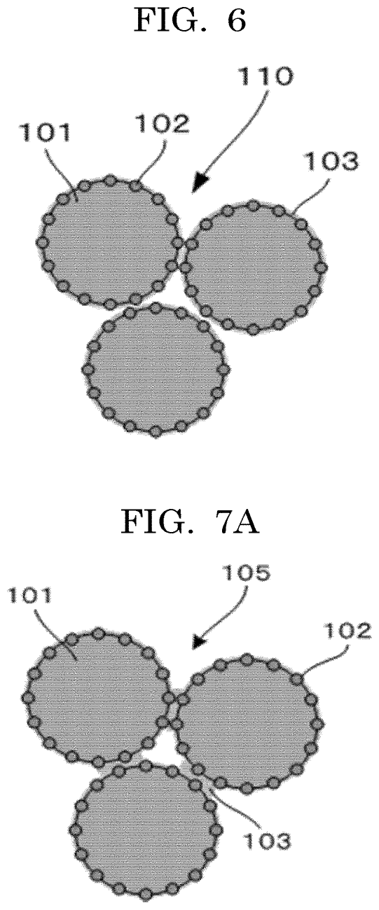

FIG. 6 is a view illustrating a powder for forming a three-dimensional object according to the fifth embodiment of the present disclosure. A powder for forming a three-dimensional object 110 of FIG. 6 satisfies the following formula: S_{B}>S_{A} when a core material 101 and a sintering additive 102 form a liquid phase during sintering, where SA represents solubility of the liquid phase in a solid phase and SB represents solubility of the solid phase in the liquid phase. That is, the solubility of the solid phase in the liquid phase is higher. This increases the liquid phase between the solid-phase particles, allows the voids between the solid-phase particles to be filled, and better densifies a sintered body.

In the present embodiment, the core material 101 is aluminum, the sintering additive 102 is tin, and the resin 103 is polyvinyl alcohol.

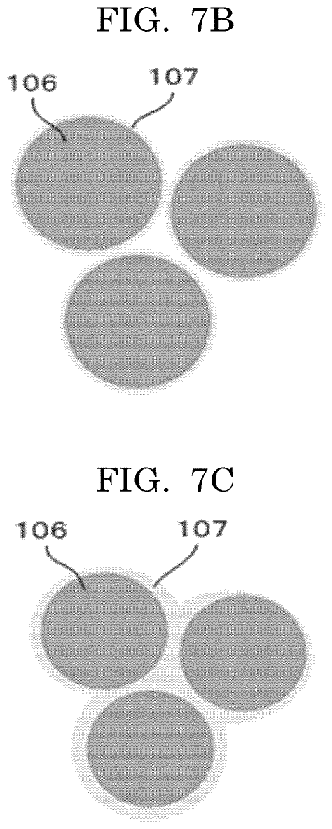

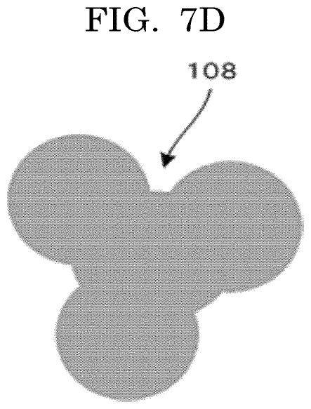

With reference to FIG. 7A to FIG. 7D, a three-dimensional object producing method using the powder for forming a three-dimensional object according to the fifth embodiment described above will be described below.

First, the powder for forming a three-dimensional object 110 according to the fifth embodiment is flattened by, for example, a roller in an object forming tank (unillustrated), and then a liquid that dissolves and solidifies the coating resin is dropped to an object forming region. These steps are repeated to produce a pre-sintering precursor 105 (hereinafter may also be referred to as “green body”) as illustrated in FIG. 7A.

Next, as illustrated in FIG. 7B, the green body 105 is heated at a temperature higher than or equal to the pyrolysis temperature of the resin in a degreasing/sintering furnace. As a result, the green body 105 is degreased of the resin component.

Next, as illustrated in FIG. 7C, the green body is further heated at a high temperature. As a result, the core material 101 and the sintering additive 102 form a liquid phase 107 at the contact point between the core material 101 and the sintering additive 102, and the liquid phase expands and enables densification between solid-phase particles. In this way, liquid-phase sintering is promoted.

Finally, as illustrated in FIG. 7D, sintering terminates, and a dense sintered body 108 having no voids or compositional variation is obtained.

### <Sixth Embodiment>

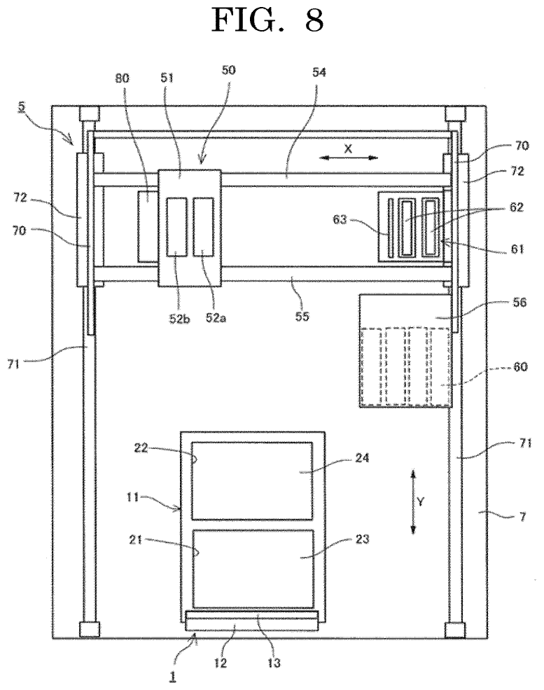

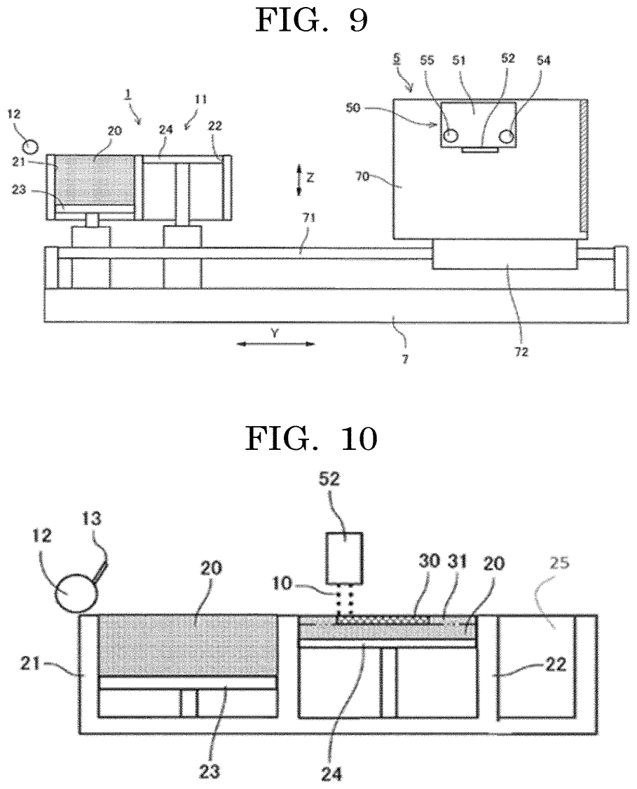

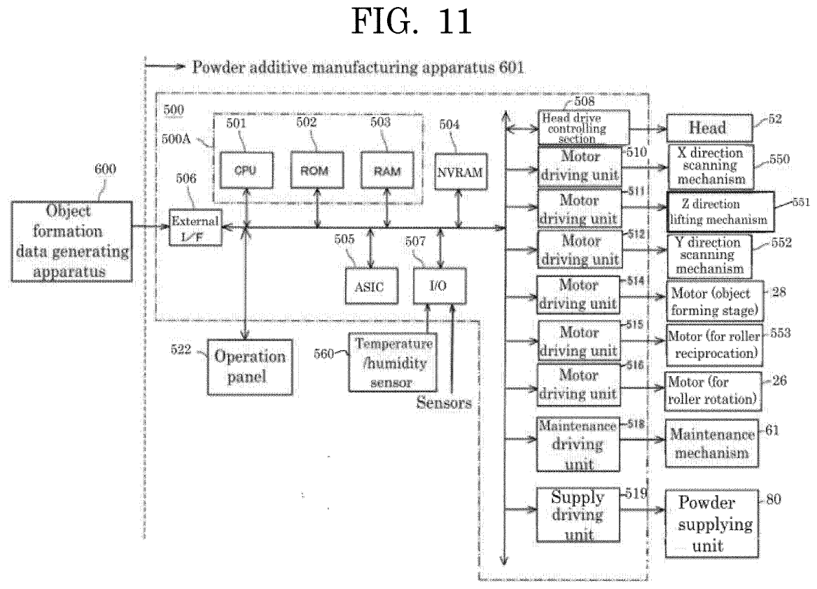

FIG. 8 is a schematic plan view illustrating an example of a three-dimensional object producing apparatus according to the sixth embodiment. FIG. 9 is a schematic side view of the three-dimensional object producing apparatus illustrated in FIG. 8. FIG. 10 is an enlarged side view illustrating an object forming section of the three-dimensional object producing apparatus illustrated in FIG. 8. FIG. 11 is a block diagram illustrating the three-dimensional object producing apparatus of the present disclosure.

As illustrated in FIG. 8 to FIG. 11, a three-dimensional object producing apparatus 601 includes a powder supplying unit 80 configured to supply a powder, an object forming section 1 in which an object forming layer 30, which is a layered object formed of powder particles bound with each other, is formed, and an object forming unit 5 configured to discharge a water-based ink 10a as a first liquid and an organic solvent-based ink 10b as a second liquid to a powder layer 31 densely laid in a layer form in the object forming section 1 to form a three-dimensional object. The water-based ink 10a and the organic solvent-based ink 10b may be referred to collectively as “object forming liquids 10”.

The object forming section 1 includes a powder tank 11, and a flattening roller 12 as a rotating body, which is a flattening member (or a recoater). The flattening member may be, for example, a plate-shaped member (blade) instead of a rotating body.

The powder tank 11 includes a supplying tank 21 configured to supply a powder 20, and an object forming tank 22 in which object forming layers 30 are laminated to form a three-dimensional object. As a supplying stage 23, the bottom of the supplying tank 21 to be supplied with the powder from the powder supplying unit 80 before object formation is liftable upward and downward in the vertical direction (height direction). Likewise, as an object forming stage 24, the bottom of the object forming tank 22 is liftable upward and downward in the vertical direction (height direction). Object forming layers 30 are additively manufactured over the object forming stage 24 as a three-dimensional object.

The supplying stage 23 is lifted upward and downward in the direction of the arrow Z (height direction) by means of a motor, and the object forming stage 24 is likewise lifted upward and downward in the direction of the arrow Z by means of a motor 28.

The flattening roller 12 is configured to supply the powder 20, which has been supplied onto the supplying stage 23 of the supplying tank 21, to the object forming tank 22, and level off and flatten the powder 20 as a flattening member, to form a powder layer 31.

The flattening roller 12 is disposed reciprocably relative to the stage surface of the object forming stage 24 (stage surface: a surface over which the powder 20 is placed) in the direction of the arrow Y along the stage surface, and is moved by means of a Y direction scanning mechanism 552. The flattening roller 12 is driven to rotate by means of a motor 26.

The object forming unit 5 includes a liquid discharging unit 50 configured to discharge the object forming liquids 10 to the powder layer 31 over the object forming stage 24.

The liquid discharging unit 50 includes a carriage 51, and two (may be one or three or more) liquid discharging heads (hereinafter, referred to simply as “heads”) 52a and 52b mounted on the carriage 51.

The carriage 51 is movably held on guide members 54 and 55. The guide members 54 and 55 are liftably held on side panels 70 and 70 on both sides.

The carriage 51 is reciprocated in the main scanning direction, which is the direction of the arrow X (hereinafter, referred to simply as “X direction”, the same applies to Y and Z), by means of an X direction scanning mechanism 550 described below, via a main scanning movement mechanism formed of a pulley and a belt.

The two heads 52a and 52b (hereinafter, referred to as “heads 52” when the two heads are not distinguished from each other) each have two nozzle lines in each of which a plurality of nozzles through which a liquid is discharged are arranged. The two nozzle lines of one head 52a are configured to discharge the water-based ink 10a as the first liquid. The two nozzle lines of the other head 52b are configured to discharge the organic solvent-based ink 10b as the second liquid. The configuration of the heads is not limited to as described above.

A plurality of tanks 60 containing the water-based ink 10a and the organic solvent-based ink 10b respectively are mounted on a tank loading section 56, and the inks are supplied into the heads 52a and 52b through, for example, supplying tubes.

A maintenance mechanism 61 configured to maintain and repair the heads 52 of the liquid discharging unit 50 is disposed at one side in the X direction.

The maintenance mechanism 61 mainly includes caps 62 and a wiper 63. The maintenance mechanism 61 is configured to bring the caps 62 into close contact with the nozzle surfaces (surfaces in which the nozzles are formed) of the heads 52 and suck the object forming liquids through the nozzles, in order to get rid of the powder clogging the nozzles or the object forming liquids having thickened. The maintenance mechanism 61 is also configured to subsequently wipe the nozzle surfaces with the wiper 63 to form a meniscus in the nozzles (the nozzles are at negative pressure internally). While the object forming liquids are not being discharged, the maintenance mechanism 61 covers the nozzle surfaces of the heads with the caps 62 to prevent mixing of the powder 20 into the nozzles or drying of the object forming liquids 10.

The object forming unit 5 includes slider units 72 movably held on guide members 71 disposed over a base member 7, and the entire object forming unit 5 can reciprocate in the Y direction (sub-scanning direction) orthogonal to the X direction. The entire object forming unit 5 is reciprocated in the Y direction by means of the Y direction scanning mechanism 552 including a motor driving unit 512 described below.

The liquid discharging unit 50 is disposed liftable upward and downward in the direction of the arrow Z together with the guide members 54 and 55. The liquid discharging unit 50 is lifted upward and downward in the Z direction by means of a Z direction lifting mechanism 551 including a motor driving unit 511 described below.

The object forming section 1 will be described in detail below.

The powder tank 11 has a box-like shape and includes three tanks with an opened top, namely the supplying tank 21, the object forming tank 22, and an excessive powder receiving tank 25. The supplying stage 23 and the object forming stage 24 are disposed liftably upward and downward in the supplying tank 21 and the object forming tank 22 respectively.

The side surface of the supplying stage 23 is disposed in contact with the internal surface of the supplying tank 21. The side surface of the object forming stage 24 is disposed in contact with the internal surface of the object forming tank 22. The upper surfaces of the supplying stage 23 and object forming stage 24 are kept level.

The flattening roller 12 transfers and supplies the powder 20 from the supplying tank 21 to the object forming tank 22, and levels off and flattens the surface to form a powder layer 31, which is the powder in a layer state having a predetermined thickness.

The flattening roller 12 is a rod-like member longer than the internal dimension of the object forming tank 22 and the supplying tank 21 (internal dimension: width of a portion supplied or filled with the powder), and is reciprocated by in the Y direction (sub-scanning direction) along the stage surfaces by means of the Y direction scanning mechanism 552.

The flattening roller 12 is configured to horizontally move from outside the supplying tank 21 in a manner to pass above the supplying tank 21 and the object forming tank 22 while being rotated by means of the motor 26. In this way, the powder 20 is transferred and supplied to the object forming tank 22, and the flattening roller 12 flattens the powder 20 while passing above the object forming tank 22, to form a powder layer 31.

As illustrated in FIG. 9, there is provided a powder removing plate 13, which is a powder removing member configured to come into contact with the circumferential surface of the flattening roller 12 to remove the powder 20 adhering to the flattening roller 12.

The powder removing plate 13 is configured to move together with the flattening roller 12 in a state of having contact with the circumferential surface of the flattening roller 12. The powder removing plate 13 may be disposed in a counter direction or a forward direction when the flattening roller 12 rotates in the rotating direction to perform flattening.

In the present embodiment, the powder tank 11 of the object forming section 1 includes two tanks, namely the supplying tank 21 and the object forming tank 22. However, only the object forming tank 22 may be provided, and the powder may be supplied to the object forming tank 22 from the powder supplying unit 80 and flattened by means of a flattening unit.

Next, the controlling section of the three-dimensional object producing apparatus 601 will be generally described with respect to FIG. 11. The controlling section 500 includes a main controlling section 500A including: a CPU 501 configured to control the entire three-dimensional object producing apparatus 601; a ROM 502 configured to store programs including a program causing the CPU 501 to perform control on a three-dimensional object forming operation including control relating to the present disclosure, and other fixed data; and a RAM 503 configured to temporarily store, for example, object formation data.

The controlling section 500 includes a nonvolatile memory (NVRAM) 504 configured to retain data even while the power supply to the apparatus is cut off. The controlling section 500 includes an ASIC 505 configured to perform image processing for performing various signal processing on image data, and process input/output signals for controlling the entire apparatus.

The controlling section 500 includes an I/F 506 configured to send and receive data and signals and used for receiving object formation data from an external object formation data generating apparatus 600. The object formation data generating apparatus 600 is an apparatus configured to generate object formation data, which is slice data representing a final object sliced per object forming layer. The object formation data generating apparatus 600 is realized by an information processing apparatus such as a personal computer.

The controlling section 500 includes an I/O 507 configured to receive sensing signals from various sensors.

The controlling section 500 includes a head drive controlling section 508 configured to control driving of the heads 52 of the liquid discharging unit 50.

The controlling section 500 also includes a motor driving unit 510 configured to drive a motor constituting an X direction scanning mechanism 550 configured to move the carriage 51 of the liquid discharging unit 50 in the X direction (main scanning direction), and a motor driving unit 512 configured to drive a motor constituting the Y direction scanning mechanism 552 configured to move the object forming unit 5 in the Y direction (sub-scanning direction).

The controlling section 500 includes a motor driving unit 511 configured to drive a motor constituting a Z direction lifting mechanism 551 configured to move (lift) the carriage 51 of the liquid discharging unit 50 upward and downward in the Z direction. In lifting upward and downward in the direction of the arrow Z, the entire object forming unit 5 may be lifted upward and downward.

The controlling section 500 includes a motor driving unit 513 configured to drive a motor 27 configured to lift the supplying stage 23 upward and downward, and a motor driving unit 514 configured to drive a motor 28 configured to lift the object forming stage 24 upward and downward.

The controlling section 500 includes a motor driving unit 515 configured to drive a motor 553 for a Y direction scanning mechanism 552 configured to move the flattening roller 12, and a motor driving unit 516 configured to drive the motor 26 configured to drive rotation of the flattening roller 12.

The controlling section 500 includes a supply driving unit 519 configured to drive the powder supplying unit 80 configured to supply the powder 20 to the supplying tank 21, and a maintenance driving unit 518 configured to drive the maintenance mechanism 61 for the liquid discharging unit 50.

The controlling section 500 includes the supply driving unit 519 configured to drive the powder supplying unit 80 to supply the powder 20.

Sensing signals of, for example, a temperature/humidity sensor 560 configured to detect the temperature and humidity as the environmental conditions of the apparatus and sensing signals of other sensors are input to the I/O 507 of the controlling section 500.

An operation panel 522 for inputting and displaying needed information of the apparatus is coupled to the controlling section 500.

The object formation data generating apparatus 600 and the three-dimensional object producing apparatus 601 constitute an object forming apparatus.

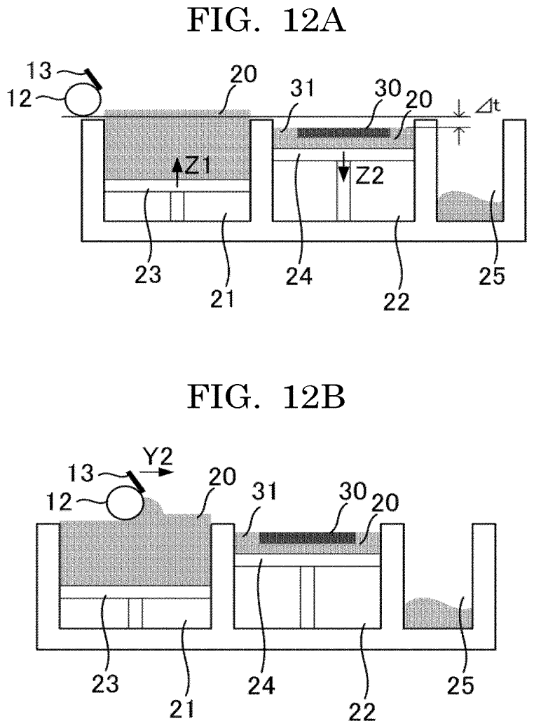

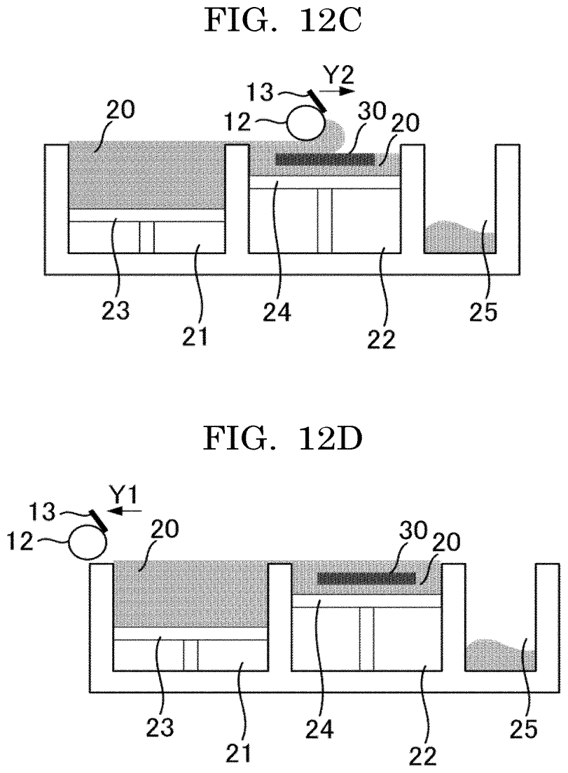

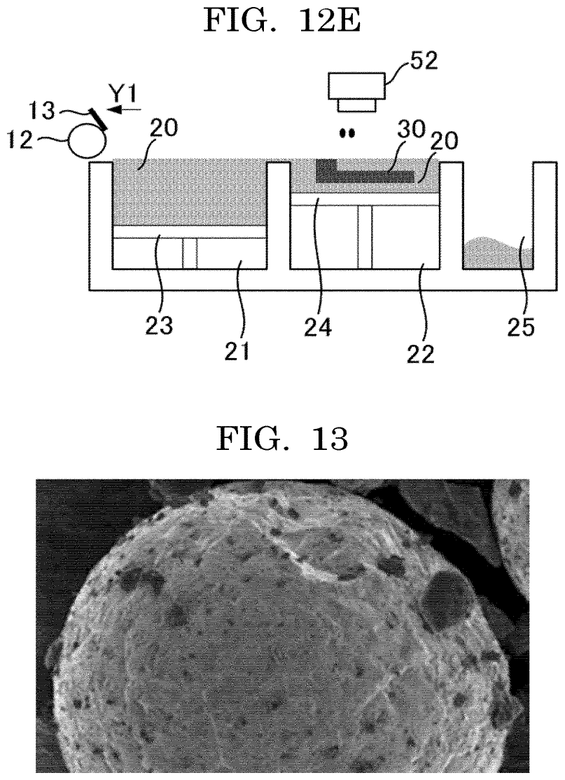

Next, the flow of object formation will be described with reference to FIG. 12A to FIG. 12E. FIG. 12A to FIG. 12E are exemplary diagrams illustrating a flow of object formation.

The description will start from a state that a first object forming layer 30 has been formed over the object forming stage 24 of the object forming tank 22.

When forming the next object forming layer 30 over the object forming layer 30, the supplying stage 23 of the supplying tank 21 is lifted upward in the Z1 direction and the object forming stage 24 of the object forming tank 22 is lifted downward in the Z2 direction as illustrated in FIG. 12A.

The distance by which the object forming stage 24 is lifted downward is set such that the interval between the upper surface of the object forming tank 22 (the surface of the powder layer) and the lower side (the lower tangential portion) of the flattening roller 12 is Δt. The interval Δt corresponds to the thickness of a powder layer 31 to be formed next. The interval Δt is preferably about from several tens of micrometers through 100 micrometers.

Next, as illustrated in FIG. 12B, the powder 20 located above the upper surface level of the supplying tank 21 is moved in the Y2 direction (toward the object forming tank 22) while the flattening roller 12 is rotated in the forward direction (the direction of the arrow), to be transferred and supplied to the object forming tank 22 (supplying of powder).

Then, the flattening roller 12 is moved in parallel with the stage surface of the object forming stage 24 of the object forming tank 22 as illustrated in FIG. 12C, to form a powder layer 31 having a predetermined thickness Δt over the object forming layer 30 over the object forming stage 24 as illustrated in FIG. 12D (flattening). After the powder layer 31 is formed, the flattening roller 12 is moved in the Y1 direction to be returned to the initial position as illustrated in FIG. 12D.

The flattening roller 12 is configured to be able to move with a constant distance kept from the upper surface level of the object forming tank 22 and the supplying tank 21. With the ability to move keeping a constant distance, the flattening roller 12 can form a powder layer 31 having a uniform thickness Δt over the object forming tank 22 or over the object forming layer 30 already formed, while conveying the powder 20 to the top of the object forming tank 22.

Subsequently, as illustrated in FIG. 12E, liquid droplets of the object forming liquids 10 are discharged from the heads 52 of the liquid discharging unit 50 to additively manufacture an object forming layer 30 in the next powder layer 31.

Next, the step of forming a powder layer 31 through supplying of the powder and flattening and the step of discharging the object forming liquids from the heads 52 described above are repeated, to form a new object forming layer 30. Here, the new object forming layer 30 and the underlying object forming layers 30 are integrated and constitute a part of a three-dimensional object.

Afterwards, the step of forming a powder layer 31 through supplying of the powder and flattening and the step of discharging the object forming liquids from the heads 52 are repeated a needed number of times, to complete a three-dimensional object (stereoscopic object).

The above-described three-dimensional object producing method and three-dimensional object producing apparatus of the present disclosure can produce a three-dimensional object having a complicated stereoscopic (three-dimensional (3D)) shape using the above-described powder for forming a three-dimensional object of the present disclosure easily, efficiently, without the risk of shape collapse before, for example, sintering, and with a good dimensional accuracy.

The three-dimensional object obtained in this way and a sintered body of the three-dimensional object have no voids or compositional variation, have a sufficient strength and an excellent dimensional accuracy, and can reproduce, for example, minute asperity and curved surfaces. Therefore, the three-dimensional object and the sintered body have an excellent aesthetic appearance and a high quality, and can be suitably used for various purposes.

### EXAMPLES

The present disclosure will be described below by way of Examples. The resent disclosure should not be construed as being limited to the Examples.

### Example 1

### <Production of Powder for Forming Three-Dimensional Object 1>

### Embedding of Sintering Additive in Core Material

An aluminum powder (available from Toyo Aluminium K.K., with a volume average particle diameter of 35 micrometers) as a core material and a silicon powder (available from Tokyo Printing & Equipment Trading Co., Ltd., with a volume average particle diameter of 2 micrometers) as a sintering additive were stirred by a Henschel mixer under the conditions described below, to embed the sintering additive in the core material.

### Stirring by Henschel Mixer

As the device, a Henschel mixer FM10B/I available from Nippon Coke & Engineering Co., Ltd. was used. The device was loaded with the aluminum powder and the silicon powder in predetermined amounts (at an aluminum powder : silicon powder ratio by volume of 99:1), and the powders were stirred at a mixer rotation speed of 1,000 rpm for a stirring time of 1 minute. FIG. 13 illustrates a superficial SEM image of a state of how the sintering additive was embedded in the core material when the stirring by the Henschel mixer was completed. From the superficial SEM image of FIG. 13 in which the black matter represents the Si powder and the white particle represents the Al particle, it can be seen that many particles of the black Si powder were struck into the surface of the Al particle.

Coating of Core Material Surface with Coating Liquid 1

Next, using a commercially available coating machine (available from Powrex Corp., MP-01), the core material embedded with the sintering additive was coated with a coating liquid (a toluene solution of polyvinyl butyral, polyvinyl butyral available from Sekisui Chemical Co., Ltd.) with a predetermined coating thickness. In the way described above, a powder for forming a three-dimensional object 1 was obtained.

### Example 2

### <Production of Powder for Forming Three-Dimensional Object 2>

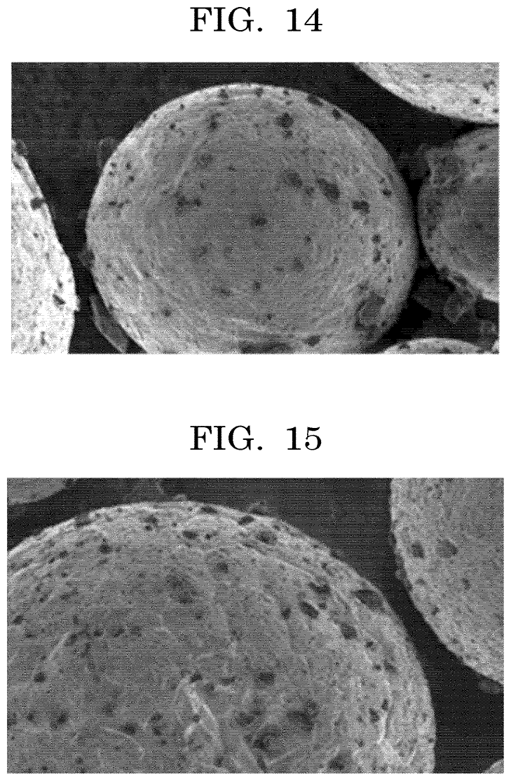

A powder for forming a three-dimensional object 2 was obtained in the same manner as in Example 1, except that unlike in Example 1, the conditions of the stirring by the Henschel mixer were changed to a mixer rotation speed of 1,000 rpm and a stirring time of 3 minutes (note, however, that in order to prevent temperature rise in the device, intervals were be provided, with a suspension per 1 minute of stirring). FIG. 14 illustrates a superficial SEM image of a state of how the sintering additive was embedded in the core material when the stirring by the Henschel mixer was completed. From the superficial SEM image of FIG. 14 in which the black matter represents the Si powder and the white particle represents the Al particle, it can be seen that many particles of the black Si powder were struck into the surface of the Al particle.

### Example 3

### <Production of Powder for Forming Three-Dimensional Object 3>

A powder for forming a three-dimensional object 3 was obtained in the same manner as in Example 1, except that unlike in Example 1, the conditions of the stirring by the Henschel mixer were changed to a mixer rotation speed of 2,000 rpm and a stirring time of 1 minute. FIG. 15 illustrates a superficial SEM image of a state of how the sintering additive was embedded in the core material when the stirring by the Henschel mixer was completed. From the superficial SEM image of FIG. 15 in which the black matter represents the Si powder and the white particle represents the Al particle, it can be seen that many particles of the black Si powder were struck into the surface of the Al particle.

### Example 4

### <Production of Powder for Forming Three-Dimensional Object 4>

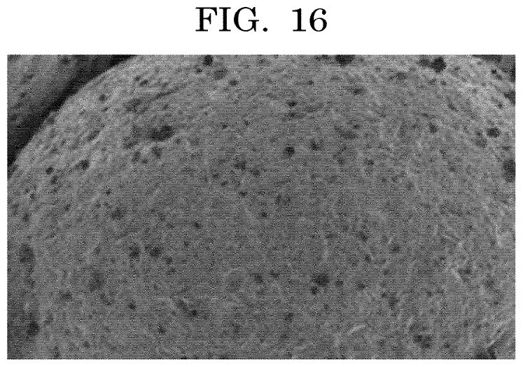

A powder for forming a three-dimensional object 4 was obtained in the same manner as in Example 1, except that unlike in Example 1, the conditions of the stirring by the Henschel mixer were changed to a mixer rotation speed of 2,000 rpm and a stirring time of 3 minutes (note, however, that in order to prevent temperature rise in the device, intervals were be provided, with a suspension per 1 minute of stirring). FIG. 16 illustrates a superficial SEM image of a state of how the sintering additive was embedded in the core material when the stirring by the Henschel mixer was completed. From the superficial SEM image of FIG. 16 in which the black matter represents the Si powder and the white particle represents the Al particle, it can be seen that many particles of the black Si powder were struck into the surface of the Al particle.

### Example 5

Using the obtained powder for forming a three-dimensional object 1, a three-dimensional object 1 was produced in the manner described below, according to a shape printing pattern having a size of 70 mm in length and 12 mm in width.

1) First, using a known powder additive manufacturing apparatus, the powder for forming a three-dimensional object 1 was transferred from a supplying-side powder storing tank to an object forming-side powder storing tank, to form a thin layer of the powder for forming a three-dimensional object 1 having an average thickness of 100 micrometers over the support.

2) Next, a liquid (toluene) was applied (discharged) to the surface of the formed thin layer of the powder for forming a three-dimensional object 1 from nozzles of a known inkjet discharging head, to dissolve the polyvinyl butyral in water, to be solidified.

3) Next, the operations of 1) and 2) were repeated until the total average thickness became a predetermined thickness of 3 mm, to additively manufacture solidified thin layers of the powder for forming a three-dimensional object 1 sequentially. Then, in a drying step, the resultant was maintained at 75 degrees C. for 10 hours with a dryer, to obtain a three-dimensional object 1.

Any excess of the powder for forming a three-dimensional object 1 was removed from the dried three-dimensional object 1 by air blowing. As a result, the three-dimensional object 1 did not undergo shape collapse, and had an excellent strength and an excellent dimensional accuracy. Moreover, a dense sintered body having no voids or compositional variation was obtained.

### Examples 6 to 8

Three-dimensional objects 2 to 4 were obtained in the same manner as in Example 5, except that unlike in Example 5, the powder for forming a three-dimensional object 1 was changed to the powders for forming a three-dimensional object 2 to 4.

The obtained three-dimensional objects 2 to 4 all had an excellent strength and an excellent dimensional accuracy. Moreover, dense sintered bodies having no voids or compositional variation were obtained.

Aspects of the present disclosure are, for example, as follows.

<1> A powder for forming a three-dimensional object, the powder including:
a core material; and
a sintering additive,
wherein the sintering additive is in a state of being at least partially embedded in the core material.

<2> The powder for forming a three-dimensional object according to <1>,
wherein the core material is a sintering-resistant material.

<3> The powder for forming a three-dimensional object according to <1> or <2>,
wherein the core material is coated with a resin.

<4> The powder for forming a three-dimensional object according to <3>,
wherein the sintering additive is coated with the resin together with the core material.

<5> The powder for forming a three-dimensional object according to any one of <1> to <4>,
wherein the sintering additive is in a state of being embedded by a length that is greater than or equal to 10% of a volume average particle diameter of the sintering additive from a surface of the core material.

<6> The powder for forming a three-dimensional object according to any one of <1> to <5>,
wherein all of elements that constitute the sintering additive are included among elements constituting the core material.

<7>The powder for forming a three-dimensional object according to any one of <1> to <6>,
wherein the powder has a liquid phase and a solid phase during sintering, and
wherein solubility of the solid phase in the liquid phase is higher than solubility of the liquid phase in the solid phase.

<8> A three-dimensional object producing method including:
forming a powder layer using the powder for forming a three-dimensional object according to any one of <1> to <7>;
applying a liquid that can dissolve the resin coating the core material of the powder for forming a three-dimensional object to an object forming region of the powder layer to solidify the object forming region;
repeating the forming and the solidifying to produce a pre-sintering precursor; and
sintering the pre-sintering precursor.

<9> A powder contained container including:
the powder for forming a three-dimensional object according to any one of <1> to <7>; and
a container,
wherein the powder for forming a three-dimensional object is filled in the container.

<10> A three-dimensional object producing apparatus including:
a powder layer forming unit configured to form a powder layer using the powder for forming a three-dimensional object according to any one of <1> to <7>;
a powder layer solidifying unit configured to apply a liquid that can dissolve the resin coating the core material of the powder for forming a three-dimensional object to an object forming region of the powder layer to solidify the object forming region;
a pre-sintering precursor producing unit configured to produce a pre-sintering precursor, which is additively manufactured layers of a solidified product of the powder layer; and
a sintering unit configured to sinter the pre-sintering precursor.

<11> A non-transitory recording medium storing a program for forming a three-dimensional object and causing a computer to execute a process including:
forming a powder layer using the powder for forming a three-dimensional object according to any one of <1> to <7>;
applying a liquid that can dissolve the resin coating the core material of the powder for forming a three-dimensional object to an object forming region of the powder layer to solidify the object forming region;
repeating the forming and the solidifying to produce a pre-sintering precursor; and
sintering the pre-sintering precursor.

The powder for forming a three-dimensional object according to any one of <1> to <7>, the three-dimensional object producing method according to <8>, the powder contained container according to <9>, the three-dimensional object producing apparatus according to <10>, and the non-transitory recording medium storing a program for forming a three-dimensional object according to <11> can solve the various problems in the related art and can achieve the object of the present disclosure.

What is claimed is:

1. A powder for forming a three-dimensional object, the powder comprising:
a core material; and
a sintering additive,
wherein the sintering additive is in a state of being at least partially embedded in the core material.

2. The powder for forming a three-dimensional object according to claim 1,
wherein the core material comprises a sintering-resistant material.

3. The powder for forming a three-dimensional object according to claim 1,
wherein the core material is coated with a resin.

4. The powder for forming a three-dimensional object according to claim 3,
wherein the sintering additive is coated with the resin together with the core material.

5. The powder for forming a three-dimensional object according to claim 1,
wherein the sintering additive is in a state of being embedded by a length that is greater than or equal to 10% of a volume average particle diameter of the sintering additive from a surface of the core material.

6. The powder for forming a three-dimensional object according to claim 1,
wherein all of elements that constitute the sintering additive are included among elements constituting the core material.

7. The powder for forming a three-dimensional object according to claim 1,
wherein the powder has a liquid phase and a solid phase during sintering, and
wherein solubility of the solid phase in the liquid phase is higher than solubility of the liquid phase in the solid phase.

8. A three-dimensional object producing method comprising:
forming a powder layer using a powder for forming a three-dimensional object, wherein the powder for forming a three-dimensional object comprises a core material and a sintering additive, with the sintering additive being in a state of being at least partially embedded in the core material;
applying a liquid that can dissolve a resin coating the core material of the powder for forming a three-dimensional object to an object forming region of the powder layer to solidify the object forming region;
repeating the forming and the solidifying to produce a pre-sintering precursor; and
sintering the pre-sintering precursor.

9. The three-dimensional object producing method according to claim 8,
wherein the core material comprises a sintering-resistant material.

10. The three-dimensional object producing method according to claim 8,
wherein the core material is coated with a resin.

11. The three-dimensional object producing method according to claim 10,
wherein the sintering additive is coated with the resin together with the core material.

12. The three-dimensional object producing method according to claim 8,
wherein the sintering additive is in a state of being embedded by a length that is greater than or equal to 10% of a volume average particle diameter of the sintering additive from a surface of the core material.

13. The three-dimensional object producing method according to claim 8,
wherein all of elements that constitute the sintering additive are included among elements constituting the core material.

14. The three-dimensional object producing method according to claim 8,
wherein the powder has a liquid phase and a solid phase during sintering, and
wherein solubility of the solid phase in the liquid phase is higher than solubility of the liquid phase in the solid phase.

15. A powder contained container comprising:
the powder for forming a three-dimensional object according to claim 1; and
a container,
wherein the powder for forming a three-dimensional object is filled in the container.

16. A three-dimensional object producing apparatus comprising:
a powder layer forming unit configured to form a powder layer using a powder for forming a three-dimensional object, wherein the powder for forming a three-dimensional object comprises a core material and a sintering additive, with the sintering additive being in a state of being at least partially embedded in the core material;
a powder layer solidifying unit configured to apply a liquid that can dissolve a resin coating the core material of the powder for forming a three-dimensional object to an object forming region of the powder layer to solidify the object forming region;
a pre-sintering precursor producing unit configured to produce a pre-sintering precursor, which is additively manufactured layers of a solidified product of the powder layer; and
a sintering unit configured to sinter the pre-sintering precursor.

17. A non-transitory recording medium storing a program for forming a three-dimensional object and causing a computer to execute a process comprising:
forming a powder layer using the powder for forming a three-dimensional object according to claim 1;
applying a liquid that can dissolve a resin coating the core material of the powder for forming a three-dimensional object to an object forming region of the powder layer to solidify the object forming region;
repeating the forming and the solidifying to produce a pre-sintering precursor; and
sintering the pre-sintering precursor.
